(19) United States
(12) Patent Application Publication
(10) Pub. No.: US 2025/0101945 A1
(43) Pub. Date: Mar. 27, 2025

(54) HYDRAULIC SYSTEM FOR A ROTOR BRAKE, ROTOR BRAKE AND WIND TURBINE

(71) Applicant: HAWE Hydraulik SE, Aschheim (DE)

(72) Inventors: Thomas WECHSEL, Aschheim (DE); Andreas NOCKER, Aschheim (DE); Jesper BERG HANSEN, Aschheim (DE); Markus RUHLAND, Aschheim (DE); Markus IMLAUER, Aschheim (DE)

(21) Appl. No.: 18/882,239

(22) Filed: Sep. 11, 2024

(30) Foreign Application Priority Data
Sep. 22, 2023 (DE) 10 2023 209 290.5

(51) Int. Cl. F03D 7/02

(52) U.S. Cl. CPC F03D 7/0248; F05B 2260/904

(57) ABSTRACT

A hydraulic system for a rotor brake of a wind turbine, where the hydraulic system has a pressure chamber, a manually operable pump device and a connection for connection to the rotor brake. The manually operable pump device is connected to the pressure chamber and the connection. The manually operable pump device comprises a coupling section for actuation. The coupling section is configured to be connected to an external device.

### CROSS REFERENCE TO RELATED APPLICATION

This application claims priority from German Patent Application No. 10 2023 209 290.5, filed on Sep. 22, 2023, the entire content of which is incorporated herein by reference in their entirety.

### FIELD OF THE INVENTION

The present invention relates to a hydraulic system for a rotor brake of a wind turbine. Furthermore, the present invention relates to a rotor brake with such a hydraulic system and with a brake caliber. In addition, the present invention also relates to a wind turbine with a rotor brake according to the invention.

### BACKGROUND OF THE INVENTION

Known wind turbines are usually equipped with a rotor brake. During maintenance of the wind turbine, the brake is applied in order to prevent unwanted and therefore possibly dangerous movement of the wind turbine rotor. For this purpose, the rotor brake regularly has at least one brake caliber, which usually acts on a brake disc arranged on the generator shaft in order to lock the generator shaft.

The use of a hydraulic system has proven itself for applying the rotor brake. These hydraulic systems known from the state of the art have a hydraulic unit and the pressure relief valves, pressure switches and changeover valves required for this purpose to supply pressure to the rotor brake. The operating pressure of the rotor brake is provided by operating the hydraulic unit in an accumulator charging mode. Once the maintenance process is complete, the hydraulic unit is switched off so that the rotor brake is released. Such a hydraulic system is known, for example, from DE 10 2007 002 137 A1. DE 10 2017 102 375 B3 discloses a hydraulic system with a manually operable emergency pump.

These well-known solutions work reliably and can be easily operated by a maintenance technician. However, the disadvantage of the known solution is the high number of relatively expensive components. It is desirable to provide a significantly more cost-effective solution, particularly in view of the reduced time required to use the hydraulic unit.

It is therefore the object of the present invention to provide a more cost-effective hydraulic system for a rotor brake of a wind turbine.

### SUMMARY OF THE INVENTION

The solution to the problem is achieved with a hydraulic system for a rotor brake of a wind turbine according to claim 1. Preferable further embodiments are described in the dependent claims.

The hydraulic system according to the invention for a rotor brake of a wind turbine has a manually operable pump device and a connection for connecting to the rotor brake. The manually operable pump device is connected to the connection. This avoids the need for an expensive hydraulic unit. Instead, the required operating pressure of the rotor brake is provided by an inexpensive manually operable pump device. According to the present disclosure, the manually operable pump device comprises a coupling section for actuation, wherein the coupling section can be coupled to an external device. In other words, the coupling section is configured to be coupled to an external device. The maintenance technician can thus actuate the pump device using the external device coupled to the coupling section and may thus generate the necessary operating pressure.

A connection in the sense of the invention does not necessarily mean a single connection. Rather, it can also mean several connections and further supply lines, for example connection options for leakage lines or the like.

Another advantage of the hydraulic system is that it has a tank chamber, with the tank chamber being connected to the manually operable pump device. The tank chamber can be used, for example, to compensate for temperature fluctuations.

The hydraulic system according to the invention preferably has a first bypass line, wherein the first bypass line connects the connection to the tank chamber, bypassing the manually operable pump device. A first closing valve can be disposed in the first bypass line. In particular, the first closing valve can be a pressure relief valve or a shut-off valve.

A closing valve configured as a pressure relief valve can be used to provide protection in the event of excess pressure. If the closing valve is configured as a manually openable shut-off valve, the maintenance technician can directly regulate the pressure applied to the connection, for example to compensate for temperature fluctuations.

Here, it is preferable if the hydraulic system has a second bypass line, wherein the second bypass line connects the connection to the tank chamber, bypassing the manually operable pump device. A second closing valve can be disposed in the second bypass line. Preferably, the second closing valve is either a pressure relief valve or a preferably manually openable shut-off valve and is different from the first closing valve. In other words, if the first closing valve in a preferred embodiment is configured as a pressure relief valve, the second closing valve is configured as a shut-off valve.

Preferably, the hydraulic system is configured as a cartridge. This design as a screw-in cartridge makes the hydraulic system particularly easy to install and integrate.

Preferably, the hydraulic system is hydraulically preloaded, preferably via a spring preload integrated in the manually operable pump device or in an integrated hydraulic accumulator. This allows temperature fluctuations and minor leaks in the brake caliber to be compensated for directly. It is conceivable that the tank chamber is configured as a hydraulic accumulator.

Preferably, the external device to be connected to the coupling section is a tool or an external motor. The maintenance technician can thus actuate the pump device using a tool and generate the necessary operating pressure. The tool can, for example, also be disposed on a cordless screwdriver or the like. It is also conceivable to use an external motor to provide the operating pressure via the manually operable pump device. This results in a hydraulic system that is particularly easy to actuate in order to provide the operating pressure required to apply the brake.

Preferably, the manually operable pump device has pressure chamber, a housing, a drive shaft and a piston element, wherein the pressure chamber is at least partially formed by the housing. The piston element is movably disposed in the pressure chamber and the drive shaft is rotatably mounted relative to the housing and connected to the piston element, wherein rotation of the drive shaft moves the piston element linearly or axially in the pressure chamber and thus relative to the housing. When the maintenance technician turns the drive shaft, the piston element moves linearly in the pressure chamber in order to generate the necessary operating pressure.

Preferably, the piston element is guided inside the housing in such a way that the piston element is prevented from rotating relative to the housing. The drive shaft can therefore be rotated relative to the housing, but cannot be moved axially or linearly. A rotational movement of the drive shaft is therefore transmitted to the piston element via a suitable interface, for example via a threaded connection between the drive shaft and the piston element.

Alternatively, it might be preferable if the drive shaft is axially movable relative to the housing and moves together with the piston element. When the drive shaft rotates, it therefore moves axially relative to the housing so that it is a rising drive shaft. This has the advantage that a separate bearing to support the rotary movement of the drive shaft, for example a roller bearing or plain bearing, is not necessary.

A fully integrated hydraulic system configured in this way can be arranged directly on the brake caliber or used as a stand-alone solution.

Preferably, the piston element has a first piston part, a second piston part and a preload element, wherein the first piston part is connected to the drive shaft and wherein the second piston part is connected to the first piston part via the preload element. A hydraulic preload of the hydraulic system can be achieved via the preload element, for example to compensate for minor leaks in the brake caliber or temperature fluctuations.

Preferably, the manually operable pump device has a locking element that can be moved between a release position and a locking position. In the locking position, the locking element secures the drive shaft against rotation relative to the housing. In the release position of the locking element, the drive shaft can be rotated relative to the housing. By moving the locking element from the release position to the locking position, the maintenance technician can safely prevent further rotation of the drive shaft and thus also a change in the operating pressure.

Alternatively, it the manually operable pump device may be a gear pump with a drive shaft, wherein the coupling section is disposed on the drive shaft. Preferably, the coupling section is disposed at an axial end of the drive shaft of the gear pump.

Due to possible leakage occurring at the gear pump, a manually unlockable non-return valve may be disposed between the gear pump and the connection. The manually unlockable non-return valve prevents a backflow from the connection to the gear pump, so that a pressure is locked between the non-return valve and the connection or a brake caliber connected to the connection and thus the brake caliber is held in the extended position. To retract the brake caliber, the manually unlockable non-return valve is manually unlocked.

Preferably, the hydraulic system has a manually operbable lever mechanism for unlocking the non-return valve. For example, the lever mechanism may be configured as a button or lever.

It is particularly preferable if the manually operable lever mechanism is connected to the drive shaft of the gear pump, whereby an axial movement of at least part of the drive shaft actuates the lever mechanism and unlocks the non-return valve. For example, the maintenance technician can use an external device attached to the coupling section to move the entire drive shaft or part of the drive shaft axially, for example by pushing it in. This unlocks the non-return valve and a rotation of the drive shaft pressurizes the connection or relieves the connection, depending on the direction of rotation.

Preferably, the manually operable pump device is a reversible manually operable pump device. This makes it possible to reduce the operating pressure applied to the connection by reversing the direction of rotation of the drive shaft.

The invention also relates to a rotor brake for a wind turbine, wherein the rotor brake has at least one brake caliber and a hydraulic system according to the invention as described above, wherein the brake caliber is hydraulically connected to the connection of the hydraulic system. Furthermore, the invention relates to a wind turbine with such a rotor brake.

The invention is explained in more detail below with reference embodiments shown in the drawings.

### BRIEF DESCRIPTION OF THE DRAWINGS

FIG. 1 is a side view of a wind turbine:

FIG. 2 is a hydraulic circuit diagram of a rotor brake with a hydraulic system according to a first embodiment the invention;

FIG. 3 is an exemplary structural configuration of a hydraulic system according to the invention according to the first embodiment;

FIG. 4 is an alternative exemplary structural configuration of a hydraulic system according to the invention according to the first embodiment;

FIG. 5 is a hydraulic circuit diagram of a rotor brake with a hydraulic system according to a second embodiment the invention; and

FIG. 6 is a hydraulic circuit diagram of an alternative to the inventive hydraulic system of FIG. 5 according to the second embodiment.

### DETAILED DESCRIPTION OF THE INVENTION

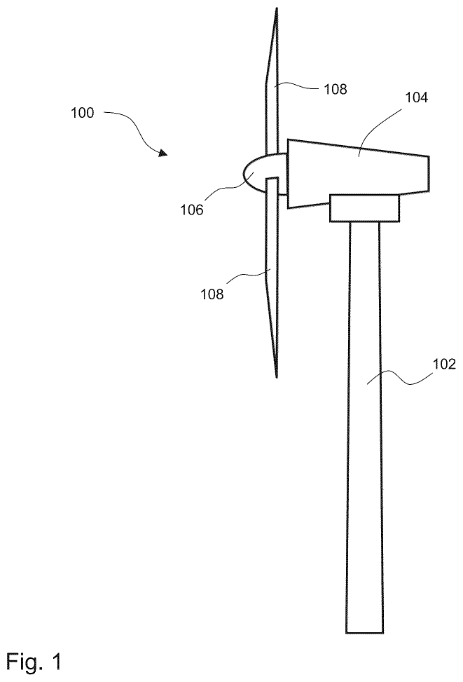

FIG. 1 shows a schematic side view of a wind turbine 100. The wind turbine 100 has a tower 102 and a nacelle 104 attached to the tower 102. A rotor 106 is rotatably mounted on the nacelle 104. The wind turbine 100 further comprises a plurality of rotor blades 108 attached to the rotor 106. Further, the wind turbine includes a pitch system (not shown) which is configured to adjust the aerodynamic angle of attack of one or all of the rotor blades 108 of the wind turbine 100 based on environmental conditions. The pitch system changes the angle of attack of the rotor blades 108 depending on the current wind speed in order to operate the wind turbine 100 with the best possible efficiency and thus with largely constant rated power. For this purpose, the rotor blades 108 are adjusted in their angular position relative to the rotor 106 via the pitch system in such a way that the best possible lift is generated. The pitch system is also configured in such a way that it prevents damage to the wind turbine 100 in strong winds by turning the rotor blades 108 into the wind. A corresponding position of the rotor blades 108 is also assumed when maintenance is due. This interrupts the lift of the rotor blades 108 and the rotor 106 comes to a standstill.

In order to prevent the rotor 106 from starting up again during maintenance of the wind turbine 100, which can be dangerous under certain circumstances, it can be locked by means of a rotor brake 1.

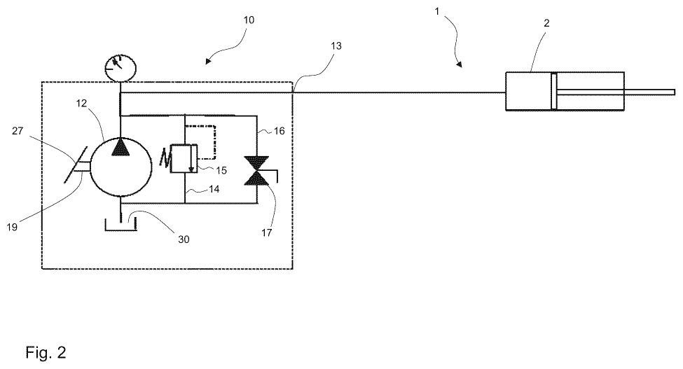

FIG. 2 shows a hydraulic circuit diagram of a rotor brake 1 according to the invention. The rotor brake 1 comprises a hydraulic system 10 according to a first embodiment, a brake caliber 2 and a brake element not shown, for example a disc brake. The hydraulic system 10 is used to generate the operating pressure required to lock the rotor 106, which is applied to the brake caliber 2 and thus applies the brake.

The hydraulic system 10, a tank chamber 30, a manually operable pump device 12 with a pressure chamber 11 and a connection 13. During maintenance of the wind turbine 100, the maintenance technician can generate the necessary operating pressure of the rotor brake 1 via the manually operable pump device 12. For this purpose, the brake caliber 2 is connected to the connection 13 of the hydraulic system 100 via a line 3 in a known manner.

Furthermore, the hydraulic system 10 has a first bypass line 14 with a first closing valve 15 configured as a pressure relief valve. Furthermore, the hydraulic system 10 can have a second bypass line 16 with a second closing valve 17 configured as a shut-off valve. The first bypass line 14 and the second bypass line 16 each connect the connection 13 directly to the tank chamber 30, bypassing the manually operable pump element 12. The pressure relief valve 15 protects the hydraulic system 10 in the event of an excess pressure. The shut-off valve 17 is configured as a manually openable shut-off valve so that the maintenance technician can reduce the pressure applied to the brake caliber 2 if necessary, for example in the event of temperature fluctuations.

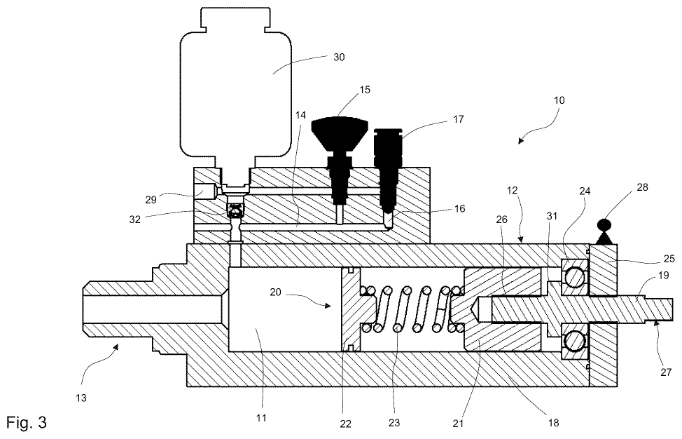

FIG. 3 shows an exemplary structural configuration of an inventive hydraulic system 10 according to the first embodiment. The manually operable pump element 12 has a housing 18, a drive shaft 19 and a piston element 20. The piston element 20 comprises a first piston part 21, a second piston part 22 and a preload element 23. The pressure chamber 11 is at least partially formed by the housing 18. The piston element 20 is arranged to move linearly within the pressure chamber 11 or the housing 18 in order to change the volume of the pressure chamber 11 and thus provide the operating pressure at the connection 13. The preload element 23 is supported on the first piston part 21 and the second piston part 22 and thus hydraulically preloads the hydraulic system 10, for example to compensate for minor leaks in the brake caliber 2.

As shown, the connection 13 is formed on an axial end face of the housing 18 and the line 3 is secured to the connection 13 by screwing, for example. Of course, the line 3 can also be secured to the connection 13 in another way.

The drive shaft 19 is rotatably supported on the housing 18 via at least one bearing 24, wherein the drive shaft 19 is not axially movable relative to the housing 18. For this purpose, the housing 18 can, for example, have an intermediate plate 25, on which the drive shaft 19 is axially supported via a circumferential ring 31 (which can be centered via the bearing 24) and is thus secured against axial movement or axial drift. Of course, the drive shaft 19 can also be secured against axial movement in other ways.

The drive shaft 19 is connected to the piston element 20 in such a way that a rotary movement of the drive shaft 19 is converted into a linear movement of the piston element 20. In the embodiment example shown, the drive shaft 19 is connected to the first piston part 21 via a threaded connection 26. The first piston part 21 is guided within the housing 18 in such a way that rotation of the first piston part 21 relative to the housing 18 is prevented. This can be achieved, for example, by means of a groove guide (not shown). Of course, other anti-rotation devices are also conceivable.

By rotating the drive shaft 19, the first piston part 21 is moved relative to the drive shaft 19 and therefore to the housing 18 due to the threaded connection 26. The linear movement of the first piston part 21 is transferred to the second piston part 22 via the preload element 23 and the volume of the pressure chamber 11 is thus increased or reduced depending on the direction of rotation of the drive shaft 19. The manually operable pump element is therefore a reversible manually operable pump element. By reversing the direction of rotation of the drive shaft 19, the operating pressure at the connection 13 can be reduced.

Alternatively, the drive shaft 19 can also be configured to rise. The drive shaft 19 is then rigidly connected to the piston element 20 or the first piston part 21 and moves axially and relative to the housing 18 during rotation. This has the advantage that the bearing 24 can be omitted and the first piston part 21 does not have to be secured against rotation.

A coupling section 27 is disposed at the axial end of the drive shaft 19 opposite the threaded connection 26. An external device, for instance a suitable tool, can engage the coupling section 27 in order to rotate the drive shaft 19. For example, the coupling section 27 can be configured as a hexagon so that the maintenance technician can actuate the manually operable pump element 12 using a cordless screwdriver with a corresponding nut, for example. However, other types of actuation via other external devices are of course also conceivable, for example via a foot or hand lever that can be coupled or via an external motor.

Furthermore, the manually operable pump element 12 has a locking element 28. The locking element 28 can be moved between a release position and a locking position. In the release position of the locking element 28, the drive shaft 19 can be rotated and the manually operable pump element 12 can be actuated. In the locking position, the locking element 28 blocks a rotary movement of the drive shaft 19 so that the operating pressure currently applied to the connection 13 cannot be changed. In the exemplary embodiment shown, the locking element 28 is configured as a locking pin, which is movable within the intermediate plate 25 in such a way that rotation of the drive shaft is blocked in the locking position. Of course, other configurations are also conceivable, for example via a switching disk that can be switched via a switching lever, which blocks rotation in one direction in each case depending on the position of the switching lever.

As also shown in FIG. 3, the pressure chamber 11 is also connected to the brake caliber 2 via a leakage line 29. In this exemplary embodiment, the tank chamber 30 is configured as an additional tank 30. The leakage line 29 and the additional tank 30 are connected to the pressure chamber 11 via a non-return valve 32. This ensures that sufficient hydraulic fluid is maintained in the hydraulic system 10 to generate the operating pressure required to actuate the brake caliber 2 or to provide the required quantity. The volume of the additional tank 30 and the leakage line 29 preferably corresponds to at least the maximum volume of the pressure chamber 11.

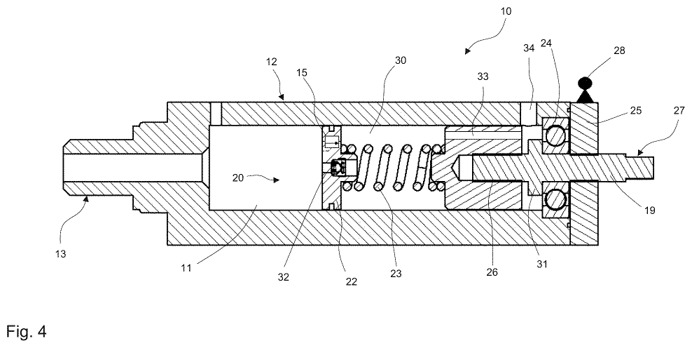

FIG. 4 shows an alternative exemplary structural configuration of an invenitve hydraulic system 10 according to the first embodiment. In this embodiment, the tank chamber 30 is formed at least partially within the housing 18. As shown, the pressure chamber 11 is delimited by the second piston part 22, so that the tank chamber 30 is also formed by the housing 18 and the second piston part 22 and is separated from the pressure chamber 11 by the second piston part 22. The second piston part 22 comprises the pressure relief valve 15 and the non-return valve 32.

A through bore 33 is formed in the first piston part 21, which communicates with an additional connection 34 on the housing. An additional tank (not shown) can be provided at the additional connection 34 in order to provide a sufficient volume of the tank chamber 30 if required.

The operating pressure is generated at connection 13 by moving the piston element 20 via the drive shaft 19. Any excess pressure can be relieved directly via the pressure relief valve 15. Hydraulic fluid can be sucked in via the non-return valve 32.

The exemplary embodiment shown in FIG. 4 can be provided as a cartridge so that it can be installed quickly and easily.

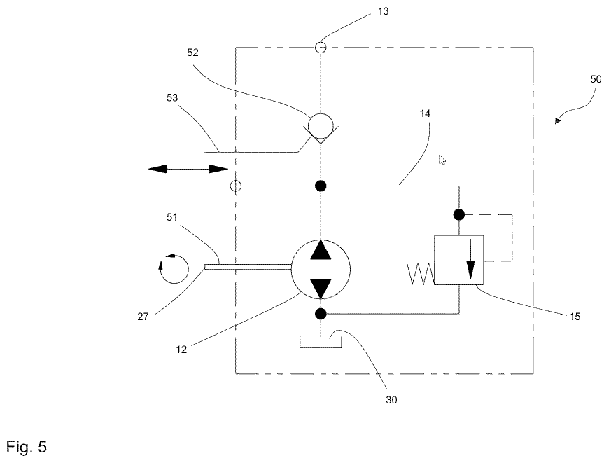

FIG. 5 shows a hydraulic circuit diagram of a hydraulic system 50 according to the invention in accordance with a second embodiment. The hydraulic system 50 has a pressure chamber 11, a tank chamber 30, a manually operable pump device 12 and a connection 13. During maintenance of the wind turbine 100, the maintenance technician can generate the necessary operating pressure of the rotor brake 1 via the manually operable pump device 12. For this purpose, the brake caliber 2 is connected to the connection 13 of the hydraulic system 100 via a line 3 as shown in FIG. 2.

Furthermore, the hydraulic system 10 has a first bypass line 14 with a first closing valve 15 configured as a pressure relief valve. The first bypass line 14 connects the connection 13 directly to the tank chamber 30, bypassing the manually operable pump element 12. The pressure relief valve 15 protects the hydraulic system 10 of excess pressure.

In this embodiment, the manually operable pump element 12 is configured as a reversible gear pump with a drive shaft 51. The coupling section 27 is dispsoed at the axial end of the drive shaft 51 of the gear pump 12, so that a maintenance technician can connect a suitable external device, for example a cordless screwdriver, to actuate the gear pump 12 by rotating the drive shaft 51, as already described above for the first embodiment.

A manually unlockable non-return valve 52 is dispsoed between the gear pump 12 and the connection 13. The non-return valve 52 opens in the direction of flow to the connection 13 and prevents pressure applied to the brake caliber 2 from being gradually reduced via the leaky gear pump 12. To retract the brake caliber 2, the manually unlockable non-return valve 52 is unlocked by the maintenance technician.

The hydraulic system 50 has a manually operable lever mechanism 53 for this purpose. In the embodiment example shown in FIG. 5, the lever mechanism 53 is in the form of a button or a lever, which the maintenance technician must actuate manually in order to unlock the non-return valve 52. This is also preferable from a safety perspective, as it can prevent the brake caliber 2 from being accidentally retracted, for example if the cordless screwdriver used as an external device is mistakenly set to the wrong direction of rotation.

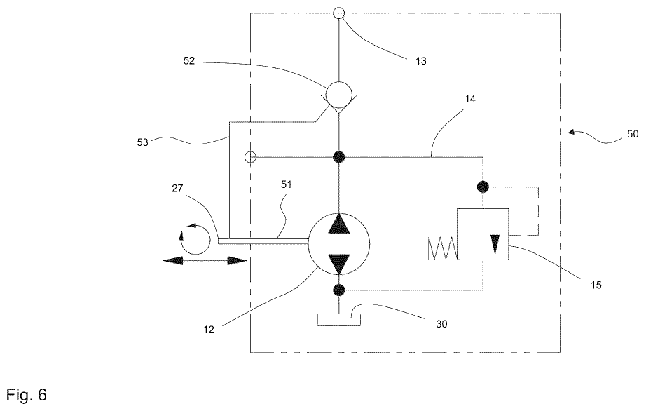

An alternative embodiment of the lever mechanism 53 is shown in FIG. 6. The lever mechanism 53 is connected to the drive shaft 51 of the gear pump 12 and is actuated by an axial movement of the drive shaft 51. The maintenance technician can actuate the drive shaft 51, for example, by exerting a corresponding force on the external device connected to the coupling section 27. It is of course also conceivable that the drive shaft 51 comprises an axially movable sleeve or the like, which is connected to the lever mechanism 53 and is axially movable relative to a base body of the drive shaft 51.

The hydraulic system 50 described with reference to FIGS. 5 and 6 can be used with a rotor brake 1 for a wind turbine 100 in the same way as the hydraulic system 10 shown in FIG. 2.

Finally, it should be noted that the numerals used here, such as “first” or “second”, do not specify a concrete order, but merely serve to differentiate between elements.

LIST OF REFERENCE SIGNS

| | |
|---|---|
| 1 | rotor brake |
| 2 | brake caliber |
| 3 | line |
| 10 | hydraulic system |
| 11 | pressure chamber |
| 12 | manually operable pump element/gear pump |
| 13 | connection |
| 14 | first bypass line |
| 15 | first closing valve/pressure relief valve |
| 16 | second bypass line |
| 17 | second closing valve/shut-off valve |
| 18 | housing |
| 19 | drive shaft |
| 20 | piston element |
| 21 | first piston part |
| 22 | second piston section |
| 23 | preload element |
| 24 | bearing |
| 25 | intermediate plate |
| 26 | threaded connection |
| 27 | coupling section |
| 28 | locking element |
| 29 | leakage line |
| 30 | tank chamber/additional tank |
| 31 | ring |
| 32 | non-return valve |
| 33 | through hole |
| 34 | additional connection |
| 50 | hydraulic system |
| 51 | drive shaft |
| 52 | manually unlockable non-return valve |
| 53 | lever mechanism |
| 100 | wind turbine |
| 102 | tower |
| 104 | nacelle |
| 106 | rotor |
| 108 | rotor blade |

1. A hydraulic system for a rotor brake of a wind turbine, wherein the hydraulic system has a manually operable pump device and a connection for connecting to the rotor brake, wherein the manually operable pump device is connected to the pressure chamber and the connection, wherein the manually operable pump device comprises a coupling section for actuation, the coupling section being connectable to an external device.

2. The hydraulic system according to claim 1, wherein hydraulic system is configured as a cartridge.

3. The hydraulic system according to claim 1, wherein the hydraulic system further comprises a tank chamber, the tank chamber being connected to the manually operable pump device.

4. The hydraulic system according to claim 3, wherein the hydraulic system comprises a first bypass line, the first bypass line connecting the connection to the tank chamber bypassing the manually operable pump element, and a first closing valve being disposed in the first bypass line.

5. The hydraulic system according to claim 4, wherein the first closing valve is a pressure relief valve or a shut-off valve.

6. The hydraulic system according to claim 3, wherein the hydraulic system comprises a second bypass line, the second bypass line connecting the connection to the tank chamber bypassing the manually operable pump element, and a second closing valve being disposed in the second bypass line.

7. The hydraulic system according to claim 6, wherein the second closing valve is different from the first closing valve and wherein the second closing valve is a pressure relief valve or a shut-off valve.

8. The hydraulic system according to claim 1, wherein hydraulic system is hydraulically preloaded, preferably via a spring preload integrated in the manually operable pump device or in an integrated hydraulic accumulator.

9. The hydraulic system according to claim 1, wherein the external device couplable to the coupling section is a tool or an external motor.

10. The hydraulic system according to claim 1, wherein the manually operable pump device comprises a pressure chamber, a housing, a drive shaft and a piston element, wherein the pressure chamber is formed within the housing, wherein the piston element is movably disposed in the pressure chamber, wherein the drive shaft is mounted rotatably relative to the housing and is connected to the piston element, wherein a rotation of the drive shaft moves the piston element linearly in the pressure chamber.

11. The hydraulic system according to claim 10, wherein the piston element is guided within the housing in such a way that rotation of the piston element relative to the housing is prevented, or wherein the drive shaft is axially movable relative to the housing and moves together with the piston element.

12. The hydraulic system according to claim 10, wherein the piston element has a first piston part, a second piston part and a preload element, wherein the first piston part is connected to the drive shaft and wherein the second piston part is connected to the first piston part via the preload element.

13. The hydraulic system according to claim 10, wherein the manually operable pump device has a locking element movable between a release position and a locking position, the locking element locking the drive shaft in the locking position in a rotationally fixed manner with respect to the housing and the drive shaft being rotatable with respect to the housing in the release position of the locking element.

14. The hydraulic system according to claim 1, wherein the manually operable pump device is a gear pump with a drive shaft, the coupling section being disposed on the drive shaft.

15. The hydraulic system according to claim 14, wherein a manually unlockable non-return valve is disposed between the gear pump and the connection.

16. The hydraulic system according to claim 15, wherein the hydraulic system comprises a manually operable lever mechanism for unlocking the non-return valve.

17. The hydraulic system according to claim 16, wherein the manually operable lever mechanism is connected to the drive shaft of the gear pump, wherein an axial movement of at least a part of the drive shaft actuates the lever mechanism and unlocks the non-return valve.

18. The hydraulic system according to claim 1, wherein the manually operable pump device is a reversible manually operable pump device.

19. A rotor brake for a wind turbine, wherein the rotor brake has at least one brake caliber and a hydraulic system according to claim 1, wherein the brake caliber is hydraulically connected to the connection of the hydraulic system.

20. A wind turbine with a rotor brake according to claim 19.
